(19) United States
(12) Patent Application Publication
(10) Pub. No.: US 2009/0197114 A1
(43) Pub. Date: Aug. 6, 2009

(54) MODIFICATION OF PB-FREE SOLDER ALLOY COMPOSITIONS TO IMPROVE INTERLAYER DIELECTRIC DELAMINATION IN SILICON DEVICES AND ELECTROMIGRATION RESISTANCE IN SOLDER JOINTS

(76) Inventors: Da-Yuan Shih, Poughkeepsie, NY (US); Donald W. Henderson, Ithaca, NY (US); Sung K. Kang, Chappaqua, NY (US); Minhua Lu, Mohegan Lake, NY (US); Jae-Woong Nah, Closter, NJ (US); Kamalesh Srivastava, Wappingers Falls, NY (US)

Correspondence Address: DAVID AKER, 23 SOUTHERN ROAD, HARTSDALE, NY, 10530, US

(21) Appl. No.: 12/254,790

(22) Filed: Oct. 20, 2008

Related U.S. Application Data
(63) Continuation-in-part of application No. 12/181,305, filed on Jul. 28, 2008.
Application No. 12/181,305 is a continuation-in-part of application No. 11/669,076, filed on Jan. 30, 2007.

(51) Int. Cl. B32B 15/01; B23K 1/20

(52) U.S. Cl. 428/647; 228/256; 228/203; 428/646

(57) ABSTRACT

A solder joint comprising a solder capture pad on a substrate having a circuit; and a lead free solder selected from the group comprising Sn—Ag—Cu solder and Sn—Ag solder adhered to the solder capture pad; the solder selected from the group comprising between 0.1 to 2.0% by weight Sb or Bi, and 0.5 to 3.0% Ag. Formation of voids at an interface between the solder and the solder capture pad is suppressed, by including Zn. Interlayer dielectric delamination is suppressed, and electromigration characteristics are greatly improved. Methods for forming solder joints using the solders.

This application is a continuation-in-part of U.S. patent application Ser. No. 12/181,305 filed on Jul. 28, 2008, which is a continuation-in-part of Ser. No. 11/669,076 filed on Jan. 30, 2007.

### BACKGROUND OF THE INVENTION

1. Field of the Invention

The present invention relates applications for predominantly lead free solders and methods of forming solder joints and related interconnect structures using such solders. While it is related to solders generally, more particularly, the invention relates to the addition of minor alloying additives such as zinc, bismuth, or antimony for suppressing interlayer dielectric delamination and electromigration in Sn based lead-free solders comprising tin and copper, and solder comprising tin, silver and copper.

2. Background Art

There has been an extensive search for Pb-free, solder, alloys in recent years. Several promising candidates have been identified for different soldering applications, which include Sn-0.7Cu, Sn-3.5Ag, Sn-3.0Ag-0.5Cu, and Sn-3.5Ag-4.8Bi (in wt. %). It is noteworthy that the compositions of most of the candidate Pb-free solders are Sn-rich solders, typically, 90 wt. % Sn or higher. This suggests that the physical, chemical, and mechanical properties of the proposed Pb-free solders are heavily influenced by the properties of pure Sn, as opposed to eutectic Sn—Pb which consists of mixtures of Sn-rich and Pb-rich phases.

The melting point of most Pb-free, commercial, solders is within the range between 208 and 227° C., which is about 30° C. to 40° C. higher than the melting point Of the Sn—Pb eutectic solder alloy. Reflow temperatures for these alloys are correspondingly higher and this fact has serious implications on the performance of packaging materials and assembly processes and can affect the integrity and/or reliability of Pb-free microelectronic packages.

Among the several Pb-free candidate solders, the near-ternary eutectic Sn—Ag—Cu (SAC) alloys, with a melting temperature of approximately 217° C., are becoming consensus candidates, especially for surface mounted card assembly, including BGA solder joints. Accordingly, extensive research and development activities are currently focused on the Sn—Ag—Cu system to understand the fundamental application issues and to evaluate the reliability risk factors associated with solder joints formed from this alloy family. In addition to the search for Pb-free solder alloys, a proper choice of a solderable layer on a substrate, lead-frame, module, or integrated circuit chip (such as under ball metallurgy (UBM) in a flip chip) is another critical factor affecting the long-term reliability of solder joints through their interfacial reactions. For Pb-free solder joints, the interfacial reactions are known to be more severe than with the eutectic, Sn—Pb, alloy, because of their high Sn content and high reflow temperature. In general, the kinetics of Cu or Ni dissolution in Sn-rich, Pb-free, solder joints is much faster and greater than with eutectic Sn—Pb solder.

Numerous investigations with Pb-free solders have been conducted to understand the mechanisms of their interfacial reactions. Several important factors affecting their interfacial reactions were identified, such as solder composition, minor alloying elements, solder volume-to-pad area ratio (the reaction rate will be high when the ratio is high), diffusion barrier layer, solder application method, and reflow condition.

In a previous study, a minor addition of Zn to SAC alloys was found to be effective in controlling the supercooling of the solder alloy below the melting point and, consequently, controlling the formation of large Ag₃Sn plates, as well as in modifying the bulk microstructure and mechanical properties of the alloys.

### SUMMARY OF THE INVENTION

It is an object of the invention to provide a solder joint having good mechanical integrity and reliability as a function of thermal aging time at elevated temperatures, such as those that may be realized under field operational conditions.

It is a further object of the invention to provide a solder joint that is void free at the interface between the solder and the pad structure to which it is attached.

It is another object of the invention to provide a method for forming such lead containing solder and lead-free solder joints.

The present invention is based on the discovery that a minor alloying addition of Zn to SAC (or other Pb free solders, or other solders containing lead) has a dramatic effect on the interfacial, reactive interdiffusion, processes between Sn and the material comprising the pad structures (Cu vs. Ni), during reflow and thermal aging and has a profound effect on the propensity for interfacial void formation, during thermal aging. The formation of interfacial voids is undesirable in that it compromises the structural integrity of solder joints when the void densities become high.

These objects and others are achieved in accordance with the invention by a solder joint, comprising a solder capture pad on a substrate having a circuit; and one of a lead containing solder or a lead free solder, the lead free solder being selected from the group comprising Sn—Ag—Cu solder, Sn—Cu solder and Sn—Ag solder adhered to the solder capture pad; the solder selected from the group comprising between 0.1 and 6.0 percent by weight Zn, so that formation of voids at an interface between the solder and the solder capture pad is suppressed. The optimized Zn content of the solder will depend on the solder volume to pad surface area ratio, among other factors.

The solder can be a Sn—Cu solder, and it can comprise less than 0.5% by weight Bi. The copper content is preferably between 0.7 and 2.0% by weight Cu.

The solder capture pad can be comprised of copper. The solder may be a Sn—Pb solder, and may contain substantially 37% by weight lead.

The invention is also directed to a solder joint, comprising a solder capture pad on a substrate having a circuit; and a Sn—Cu lead free solder adhered to the solder capture pad; the solder comprising between 0.1 and 1.0% by weight Zn, so that formation of voids at an interface between the solder and the solder capture pad is suppressed. The solder can comprise 0.5% by weight Bi. The copper content can be between 0.7 and 2.0% by weight Cu.

Another aspect of the invention is directed to a method for forming a solder joint on a solder capture pad of a substrate having a circuit, comprising applying to the capture pad a lead free solder selected from the group comprising Sn—Ag—Cu solder, Sn—Cu solder and Sn—Ag solder; and adhering the solder to the solder capture pad by melting and cooling the solder; the solder selected from the group comprising between 0.1 and 6.0 percent by weight Zn, so that formation of voids at an interface between the solder and the solder capture pad is suppressed.

The solder can be Sn—Cu solder, and can further comprise 0.5% by weight Bi. The copper content may be between 0.5 and 3.0% by weight Cu.

The solder can be heated to a temperature of less than 280 degrees C. to melt the solder, and generally between 217 and 280 degrees C. to melt the solder.

The solder capture pad can be comprised of copper. The solder may be a Sn—Pb solder, and may contain substantially 37% by weight lead.

The method can further comprise placing an organic solderability preservative (OSP) on the solder capture pad, prior to applying the solder to the pad. The method also can further comprise forming a finish on the solder capture pad of a material selected from the group consisting of electroless nickel/Immersion Gold ENIG, Electroless Nickel/Electroless Palladium/Immersion Gold ENEPIG, Direct Immersion Gold (DIG), Immersion Silver I—Ag, Immersion Tin I—Sn and Selective OSP/ENIG, DIG/ENIG.

Yet another aspect of the invention deals with the discovery of a problem associated with lead-free solders containing Ag. The presence of Ag in the solder tends to increase its hardness in direct proportionality to the amount present. Harder solders tend to be associated with interlayer dielectric delamination (ILD), which leads to solder joint failure. ILD is due primarily to the use of fragile low-k dielectric layer which is aggravated by the use of high yield strength Pb-free solders, and on large chips due to high DNP (distance from neutral point) issues. During flip-chip assembly, the CTE mismatch between a Si chip and a package substrate causes thermally induced stress/strain in the flip-chip structure. Since the chip and the substrate must be connected together by solder bumps, solder bumps may absorb the stress/strain by deforming their shape. When the solder bumps are harder, the deformation of solder bumps would be smaller, causing a higher propensity of ILD failure. The inventors have discovered that if the concentration of Ag is in the range of 0.5 to 3.0 percent, preferably in the range of 1.2 to 1.3 percent, and optimally 1.3 percent, there is a disproportionate decrease in ILD, and thus solder joint failure is drastically reduced, if not eliminated. Thus, there is a reduction in the force and stress levels transmitted to the chip via the bump structures. This reduction derives from the reduced yield stress associated with the Ag reduction. High DNP solder joints are deformed well into the plastic range in all cases. While there is a slight increase in bump strain and deformation with the Ag reduction, there is improvement in the yield stress and hardness reduction and a corresponding reduction in forces applied to the chip. Deformation and strains are similar; forces are significantly reduced.

In accordance with yet another aspect of the invention, electromigration of elements within a solder joint is drastically reduced by using the abovementioned relatively low concentration of Ag (approximately 1% in this case), with a concentration of Zn, Bi, or Sb. This makes the microstructure of the solder joint more stable, and provides the best electromigration (EM) performance, under stress conditions, such as at temperatures of 150° C., and current densities in the order of 104 and 105 Amperes/cm².

The invention is also directed to methods for supplying the required Ag, Zn, Bi, and Sb in flip-chip solder joints. In accordance with the invention, this may be accomplished by providing appropriately doped solder bumps on a wafer over the under-bump-metallurgy, doped solder bumps on the substrate over solder pads to which the wafer is to be electrically connected, or on both.

Other approaches include placing a solder of the appropriate composition, as outlined above, on a solder pad associated with a substrate, for connection to a C4 bump or Cu pillar which is connected to a wafer. The solder compositions disclosed herein also lend themselves to injection mold solder techniques, solder ball mounting techniques, and solder paste printing techniques. Yet another approach involves paste screening of an appropriate composition, which when heated, causes reflow, and solder of the appropriate composition to accomplish electrical connection.

In accordance with yet another aspect of the invention, in the absence of Cu in the Sn—Bi solder (as opposed to Sn—Ag—Cu alloys) the required levels of Zn to eliminate interfacial voiding are less than 0.1 percent by weight Zn. This occurs with a lower solder volume to pad area ratio than that which was associated with BGA experiments with SnAgCu solders, where 0.1 percent by weight Zn is generally not adequate. Thus, initial Cu levels in the solder, and other elemental levels, are important in optimizing the Zn doping levels.

### BRIEF DESCRIPTION OF THE DRAWINGS

The foregoing aspects and other features of the present invention are explained in the following description, taken in connection with the accompanying drawings, wherein:

FIG. 1 is a cross-sectional microscopic view of an interface between a copper pad and a SnAgCu solder ball containing no Zn, and showing void formation at the interface.

FIG. 1A illustrates the structure of FIG. 1 after annealing (thermal aging) in an accelerated lifetime test.

FIG. 2 is a cross-sectional, microscopic, view of an interface between a copper pad and a Sn—Ag—Cu solder ball containing 0.7% wt Zn, and showing suppression of void formation at the interface.

FIG. 2A illustrates the structure of FIG. 2 after annealing in an accelerated lifetime test.

FIG. 3 is a cross-sectional microscopic view of an interface between a copper pad and a Sn—Cu solder ball, the solder containing no Zn, and showing void formation at the interface.

FIG. 3A is an enlarged view of a portion of FIG. 3.

FIGS. 4, 4A and 4B are a cross-sectional microscopic views of an interface between a copper pad and a SnCu solder ball, the solder containing Zn, and showing suppression of void formation at the interface at reflow, after 500 hours of annealing, and after 1,000 hours of annealing, respectively.

FIG. 5A is a plot of the EM performance of a conventional Sn—Ag—Cu solder.

FIG. 5B is a plot of the EM performance a Sn—Ag—Cu solder containing a minor amount of Zn in accordance with the present invention

FIG. 6 is an enlarged schematic illustration of a chip assembled to a substrate using solder bump technology as an application of the present invention.

FIG. 7 is an enlarged schematic illustration of a chip assembled to a substrate using copper columns and solder bump technology as a further application of the present invention.

### DETAILED DESCRIPTION OF THE PREFERRED EMBODIMENTS

In one embodiment of the invention, bulk ingots or wire of Sn—Cu binary eutectic solder are doped with a small amount (0.1-6.0%) of Zn. During molten solder injection in C4NP wafer bumping process the molten solder will first fill the cavities in the mold then solidify. Solder in filled mold cavities is then aligned and transferred to the wafer, which has ball limiting metallurgy (BLM) pads with a Cu surface, serving as a solderable layer. In addition to Zn a small amount of Bi can be added to the solder to suppress Sn pest. Cu content can be increased to 0.7-2.0% (instead of the eutectic composition of 0.9 wt %) to further reduce Cu consumption to allow thinner sputtered Cu to be used.

In another embodiment and series of experiments, Sn—Ag—Cu solder alloys (in the form of solder balls, about 890 um in diameter), were commercially produced for a ball grid array (BGA) module assembly. Solder compositions included: Sn-3.8Ag-0.7Cu (SAC), Sn-3.8Ag-0.7Cu-0.1Zn (SAC+0.1Zn) and Sn-3.8Ag-0.7-Cu-0.7Zn (SAC+0.7Zn) (in wt. % with a nominal variation of 0.2 wt. %). The small amount of Zn was added to SAC alloys in a commercial process of producing BGA solder balls. The melting point of the SAC alloys (about 217° C.) was measured by differential scanning calorimetry and was not much affected by the minor additions of Zn.

The microstructures of SAC solder balls both initially and slow cooled (0.02° C./sec) were examined to find any microstructure changes due to the addition of Zn and different cooling rates. To reveal the solder microstructure more clearly, the b-Sn matrix is lightly etched with a diluted etchant of 5% HNO3/3% HCl/92% CH3OH for several seconds. Focused ion-beam (FIB) channeling images are used to record the random orientation of the Sn dendrites and estimate BGA grain orientations by noting contrast reversal when tilting the sample through the [110] Sn dendrite preferential growth direction. The FIB technique is also used to cut a thin slice from solder joint interfaces for high resolution TEM analysis.

Electron probe microanalysis (EPMA) is used to produce x-ray dot maps of the complex Sn—Ag—Cu microstructure to reveal the spatial distribution of fine intermetallic particles (Ag3Sn and Cu6Sn5) in inter-dendritic regions. Quantitative chemical analysis with the EPMA determines differences in alloy composition as a function of location within a solder joint.

High-resolution TEM analysis combined with energy-dispersive x-ray (EDX) spectroscopy provides useful information about the distribution of Zn atoms near the interfaces and the chemical identification of small particles of intermetallic compounds (less than 1000 nm diameter) below the resolution of EPMA.

The interfacial reactions of SAC+Zn solders were investigated with BGA solder balls attached to a plastic module having Cu or Au/Ni(P) pads. The reflow is performed in a forced convection oven under a N2 atmosphere with the peak temperature ranging from 235 to 245° C. Multiple reflows up to 10 cycles are applied to observe the formation of intermetallic compounds as a function of reflow time. The interfacial reactions of SAC+Zn solders in the solid-state is also investigated with solder joints thermally aged by annealing at 150° C. up to 1000 hr.

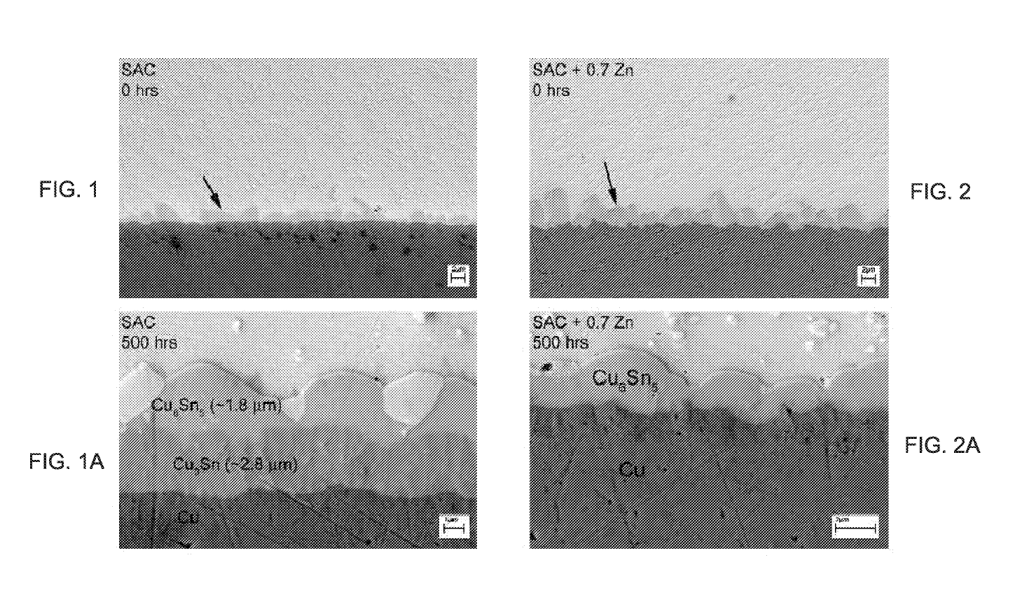

Referring to FIG. 1 (un-annealed) and to FIG. 1A (annealed), upon an extended annealing of SAC joints in contact with Cu, at 150° C., voids are observed at the interface between Cu and the IMCs. They can grow and coalesce into a void layer as the annealing time increases. This void structure can drastically reduce the joint strength of Pb-free solder joints. At an early stage, the presence of voids is difficult to detect by conventional mechanical testing such as the lap shear or ball shear test, normally conducted at a slow strain rate.

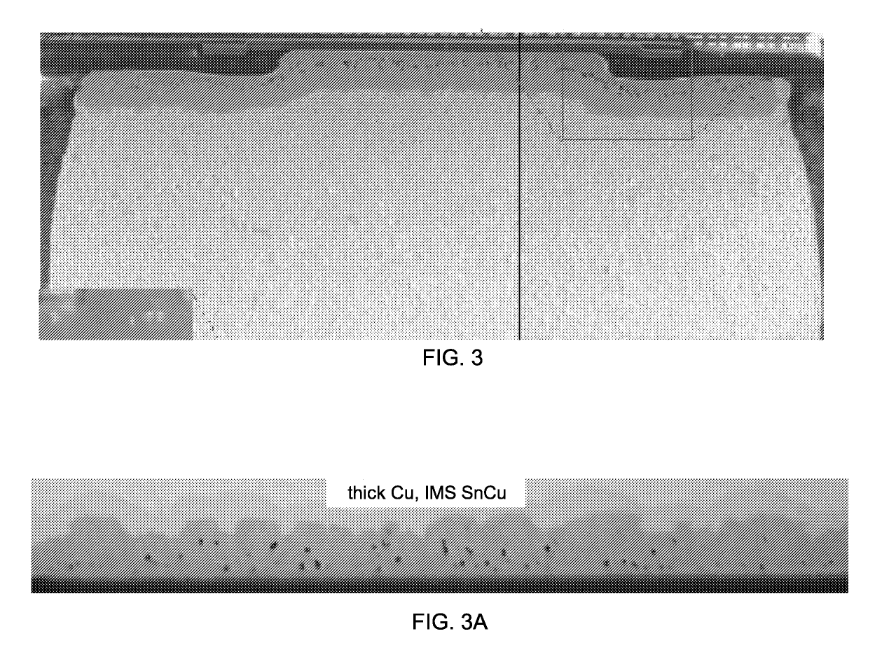

To confirm the void growth in SAC joints during the solid-state annealing, both SAC and SAC+Zn joints on Cu pads are subjected to a long-term annealing at 150° C. for up to 1000 hr. FIGS. 2 and 2A compare the IMC growth in SAC+0.7Zn solder joints with the control samples of SAC annealed at 150° C. (FIGS. 1 and 1A). For 500 hours of annealing, the SAC joint shows two layers of Cu—Sn IMC (Cu₆Sn₅ and Cu₃Sn) being about equal in thickness. However, for the SAC+0.7Zn joint, the growth of the second, IMC, layer, Cu₃Sn, was very much suppressed to a thin layer, probably less than 0.1 um thick. It is believed that retardation of Cu₃Sn IMC growth may be attributed to an accumulation of Zn atoms at the interface between the Cu₃Sn phase and the underlying Cu pad.

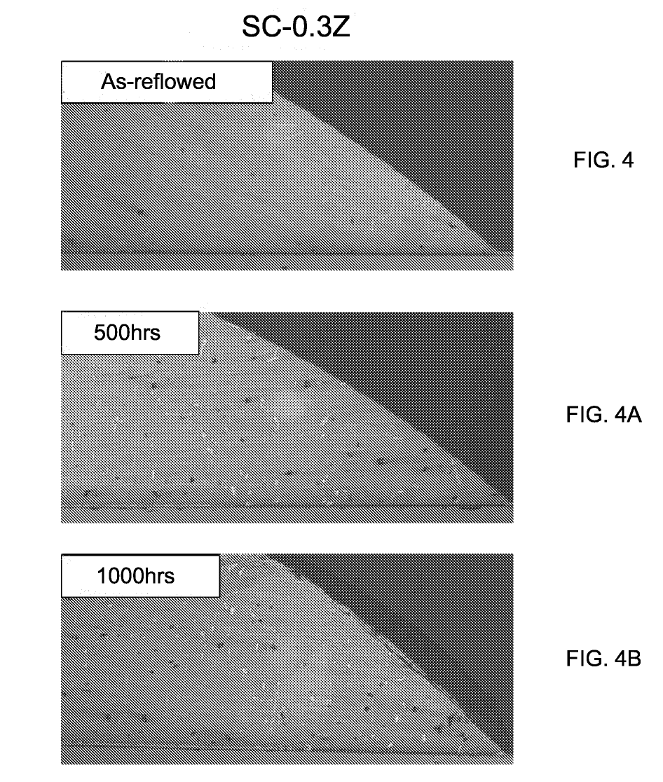

Referring to FIG. 3 and FIG. 3A, very similar issues concerning IMC's and void formation exist for an injection molded SnCu (Sn-0.7Cu) solder ball reflowed on a thick Cu pad.

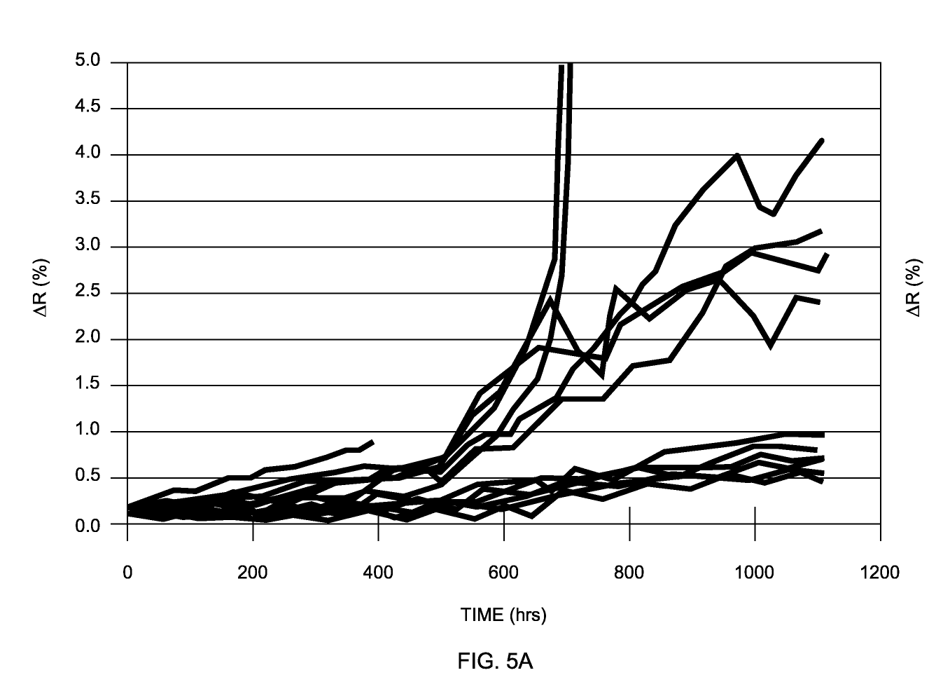

Referring to FIG. 4 the presence of 0.3% wt Zn in the Sn—Cu alloy (Sn-0.7Cu-0.3Zn) solder of FIG. 3 virtually eliminates void formation at reflow. In FIG. 4A, at 500 hours of annealing at a temperature of 150 degrees IMC and void formation are present, but greatly suppressed. This is also the case in FIG. 4B, after 1000 hours of annealing.

In some cases, the linear density of voids at the solder-pad interface may be as high. Densities with more than 1 void per micron have been found, after annealing (thermal aging), without the presence of Zn in the Sn containing solder. Such high void densities inevitably result in extreme mechanical fragility and the loss of solder joint reliability under relatively low mechanical forces. For a similar interface, when Zn is added to the solder, the linear density has been shown to drop as low as one void per 580 microns, after thermal aging. This may have extreme consequences for differences in the service life of the solder joint. Such solder joints maintain their mechanical reliability and are not subject to the early catastrophic failure in mechanical shock or other situations where the solder joint is mechanically loaded.

Thus, the inventors have discovered that in tin rich solders, whether containing lead, or lead free, Zn segregates to the interface and changes the reactive interdiffusion processes, such that, Cu₃Sn is retarded in its development on Cu pad structures. In addition, it appears that there is a very thin, Zn enriched, layer, lying directly between the Cu₃Sn phase and the Cu. As emphasized below, the required levels of Zn needed to effectively suppress void formation are in many cases surprisingly low. The required compositional levels in the solder depend on the solder volume to pad area ratio.

### Example 1

A 0.025 inch (0.635 mm) diameter solder ball is reflowed on a single 0.022 inch (0.559 mm) diameter Cu pad, voiding is prevented, with only 0.1 wt % Zn in the initial solder ball.

### Example 2

A solder joint is created with two opposed Cu pads, using a 0.025 inch (0.635 mm) diameter solder ball and 0.022 inch (0.559 mm) diameter pads, some voiding is found with 0.1 wt % Zn present in the initial solder ball. The outcome with one Cu pad and one Ni pad remains undefined for these ball and pad sizes. But, Zn does react at the Ni pad surface. With 0.3 wt % Zn in the solder and the same ball and pad geometry, voiding is prevented with dual Cu pads. Thus, for these typical BGA situations, generally 0.6 or less % wt Zn is more than adequate to suppress void growth.

The important metric in this situation is the ratio of the quantity of available Zn in the solder to the pad surface area. This relationship may be expressed in units of grams of Zn per square micron (μ²) of pad area. In the case and associated geometry described above, based on the fact that 0.1 wt % Zn is barely adequate for the ball and pad geometry, with a single Cu pad (but not two pads), and ignoring any opposed Ni pad structure, the following relationship is empirically developed:

For the Pb-free high-Sn solders, approximately 4×10⁻¹² grams of Zn or more are required per μ² of Cu pad surface area, to suppress voiding in high Sn solder joints with Cu pad structures, where the plated Cu is prone to voiding. This ratio is the critical metric to control voiding in the solder joints.

This metric is based on the 0.025 inch (0.635 mm) diameter solder ball and 0.022 inch (0.559 mm) diameter pad case, outlined above. The metric, above, is applicable to all such solder joints (with adjustment for the possible use of a Ni pad, as the Ni will react with Zn and require an adjustment of the amount of Zn).

Ultimately, the concentration of Zn required to suppress void formation in a high Sn content solder depends upon the solder volume to pad area ratio.

For 0.025 inch (0.635 mm) diameter solder balls and dual 0.022 inch (0.559 mm) diameter pad structures, the compositional level would be approximately 0.2 wt % Zn in the solder. This is a “workable” composition, based on typical reflow processing.

For a 0.003 inch (0.076 mm) diameter C4 bump and dual Cu pad structures, the solder volume to pad area ratio is much different. The volume to surface area ratio is much smaller.

Making adjustment for this surface area to solder volume (for a 0.003 inch (0.076 mm) diameter, C4, bump and dual Cu pad structures, the solder concentration must be much higher) on the order of 3 to 4 wt % Zn in the solder, and in some applications as high as 6 wt %. This concentration in the solder tends to make the alloy much more difficult to process. Areas of non-wetting in a flip chip attachment process can be a significant problem, which may be addressed by revision in the chip join operations, including the use of fluxes suitable for the presence of ZnO.

For a single Cu pad structure with an opposed Ni pad, the above estimate for the Zn concentration in the solder cannot be reduced by substantially one-half. The Ni pad will consume a considerable fraction of the available Zn. Thus, concentrations much higher than 1 wt % Zn are used in the C4 case.

### Example 3

In the case of high-Sn lead containing solders (such as Sn-37Pb) on Cu-based pad structures, excessive pore formation is far from typical. However, in 5-10% of all Cu pad structures, testing leads to severe voiding in the Cu₃Sn layer. Moreover, extrapolation of accelerated aging results by means of an empirical Arrhenius dependence may be seen to overestimate “life in service” by a factor of 40 or more, under some circumstances. This situation derives from the fact that the growth rate of the voids can be highly variable and the degree of voiding is seen to depend completely on the nature of the Cu pad and has its origins in the plating process used to create the pad structure. Generally, excessive void formation has not been found when high purity, wrought Cu is used. However, under certain conditions it occurs sporadically with plated Cu structures currently supplied to the electronics industry and leads to solder joint fragility. However, voiding may also be significantly reduced by annealing of plated Cu pads at a temperature of approximately 550° C., prior to use in solder joint structures.

As noted above, it has been found that the presence of Ag in the solder tends to increase its hardness in direct proportionality to the amount present. Harder solders tend to be associated with interlayer dielectric delamination (ILD), which leads to solder joint failure. The inventors have discovered that if the concentration of Ag is in the range of 0.5 to 2.0 percent, preferably in the range of 1.2 to 1.3 percent, and optimally 1.3 percent, there is a disproportionate decrease in ILD, and thus solder joint failure is drastically reduced, if not eliminated.

The following Table 1 provides microhardness values for a Sn—Ag—Cu solder. It is noteworthy that there is a significant drop in microhardness for Ag weight percentages at 1.3 percent and below. While this may not seem to be extremely large, in situations with a significant differential in coefficient of thermal expansion between, for example, a semiconductor chip and the substrate to which it is soldered by flip chip techniques, such decrease in hardness is extremely significant in reducing stress an the solder joint, and thus significantly reducing, if not totally eliminating interlayer dielectric delamination.

TABLE 1
Module level solder joint microhardness
and indentation measurements.

| | | | Hardness, |
|---|---|---|---|
| | | | HV Mean |
| wt % Sn | wt % Ag | wt % Cu | (std dev) |
| 97.6 | 2.2 | 0.2 | 16.0 (0.6) |
| 98.5 | 1.3 | 0.2 | 14.5 (0.8) |
| 98.5 | 0.9 | 0.6 | 14.0 (0.0) |
| 98.6 | 1.2 | 0.2 | 14.0 (0.6) |
| 99.5 | 0.3 | 0.2 | 12.0 (0.9) |
| 99.3 | 0 | 0.7 | 11.5 (0.5) |

In accordance with yet another aspect of the invention, electromigration of elements within a solder joint is drastically reduced by using the above mentioned relatively low concentration of Ag (approximately 1% in this case), with a concentration of Zn, Bi, or Sb. This makes the microstructure of the solder joint more stable, and provides the best electromigration performance, under stress conditions, such as at temperatures of 150° C., and current densities in the order of 104 and 105 Amperes/cm².

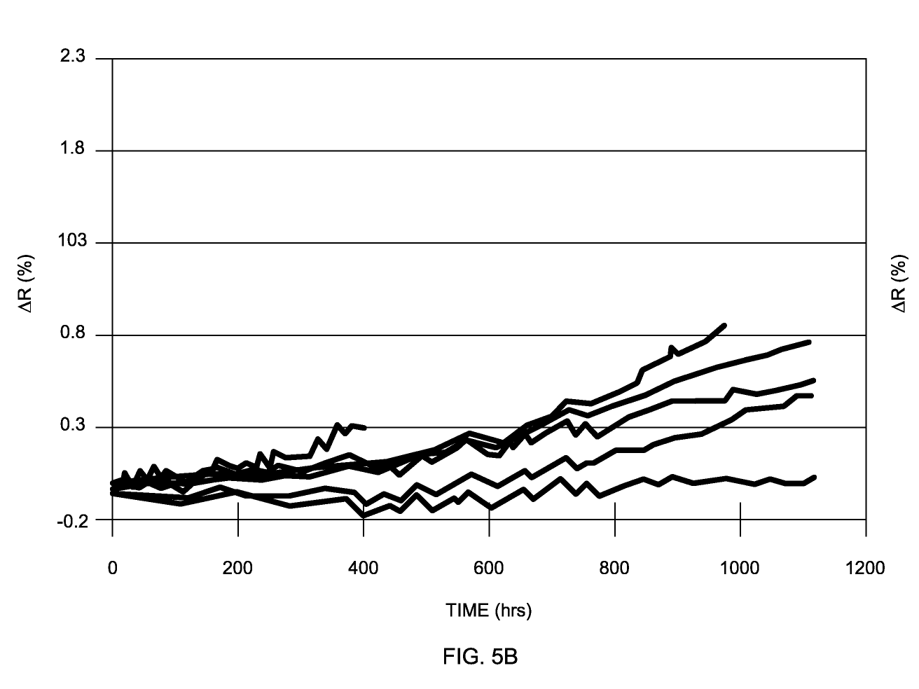

FIG. 5A is a plot of the EM performance of a conventional Sn—Ag—Cu alloy. The increase in resistance is plotted as a function of test time when the solder joints were stressed at 5.2×10³ A/cm² and 150° C. for 1100 hrs. For the conventional SAC alloy, shown in FIG. 5A, some samples showed early failures due to resistance increases that exceeded failure criteria.

In FIG. 5B, in comparison, an Sn—Ag—Cu solder in accordance with the present invention, having 1.0 percent Ag, and doped with a minor amount of Zn (0.6 percent by weight), showed significantly enhanced performance by eliminating the early failures, as shown in FIG. 5B. This quaternary solder alloy can be readily used by C4NP technology, preformed solder ball mounting technology, or solder paste screen technology.

The present invention is particularly useful in the C4NP (C4 New Process, as described, for example in U.S. Pat. Nos. 6,149,122 and 6,231,333) process, where it allows accurate compositional control of multi-component solder alloy, injected molten solder can easily incorporate small amount of Zn to suppress void formation at the CuSn intermetallics/Cu layer to allow thick Cu BLM to be used reliably.

More specifically, the C4NP process starts with a glass plate mold in which the pattern for the under bump metallurgy (UBM) input/output pads of an entire wafer are replicated in a mirror image with tiny cavities etched into the glass plate. These cavities are filled with solder as the mold is scanned below a fill head. The fill head contains a reservoir of molten solder and a slot through which the solder is injected into the mold cavities. The cavity depth and diameter determine the volume of the solder bumps that will be subsequently transferred to the wafer. The filled mold is inspected automatically and then aligned below a wafer with exposed UBM pads facing the mold. Mold and wafer are heated above the solder melting point, vapor flux is applied to ‘scrub’ the pads and solder surface and then brought into close proximity/contact. The solder forms spherical balls which transfer from the mold to the UBM pads on the wafer, where they wet and solidify. Wafer and mold are separated, and the mold is cleaned for reuse.

Thus, the solders in accordance with the present invention can be used with this conventional C4NP process, with spaces between connections (connection pitch) having been demonstrated to be as low as 50 microns, and even smaller pitch being possible. On the other hand, prefabricated solder balls formed from the solder in accordance with the invention can be used for 150 micron pitch connections. Finally, for coarser pitch, the solder compositions of the present invention may be used with paste screening techniques.

It is also possible to apply solder bumps formed of solder in accordance with the invention to the solder pads of the substrate to which the semiconductor chip is to be assembled, or to both the UBM of the semiconductor chip and the solder pads of the substrate.

With respect to the substrate, injection mold solder (IMS) techniques, solder paste screening techniques, and preformed solder ball mounting techniques can be used.

For fine pitch applications, injection mold solder (IMS) techniques are preferred. Generally paste screening and conventional solder ball techniques are not applicable to fine pitch applications under 120 micron pitch.

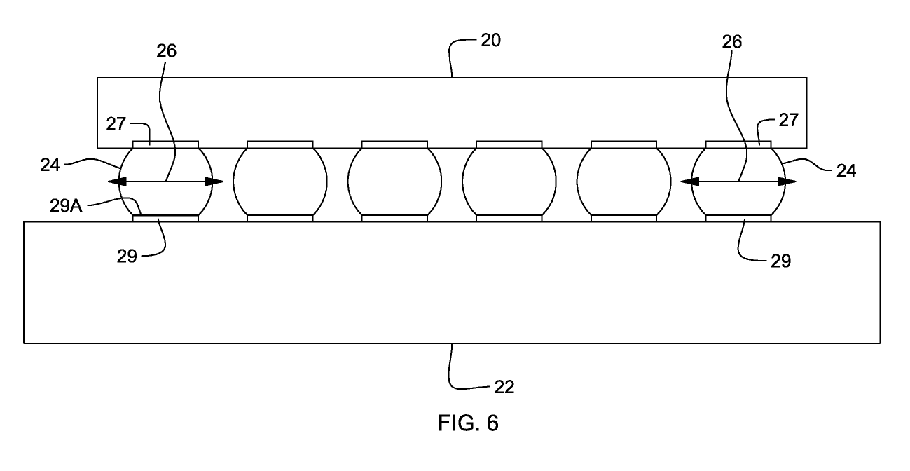

Reference is made to FIG. 6, wherein a die or chip 20 (typically an integrated circuit silicon chip) is electrically interconnected to a substrate 22 by a series of solder bumps 24, as is well known in the art. The solder bumps adhere to the UBM 27 of the chip 20 and solder pads 29 of the substrate 22. The typically small height to width aspect ratio (<1) of standard flip chip bumps makes the solder prone to mechanical stresses, which are greatest at the plane represented by arrows 26, as the chip power and temperature varies over its life. This CTE mismatch problem is aggravated as chips get larger and thus the DNP (distance to neutral point) is increased.

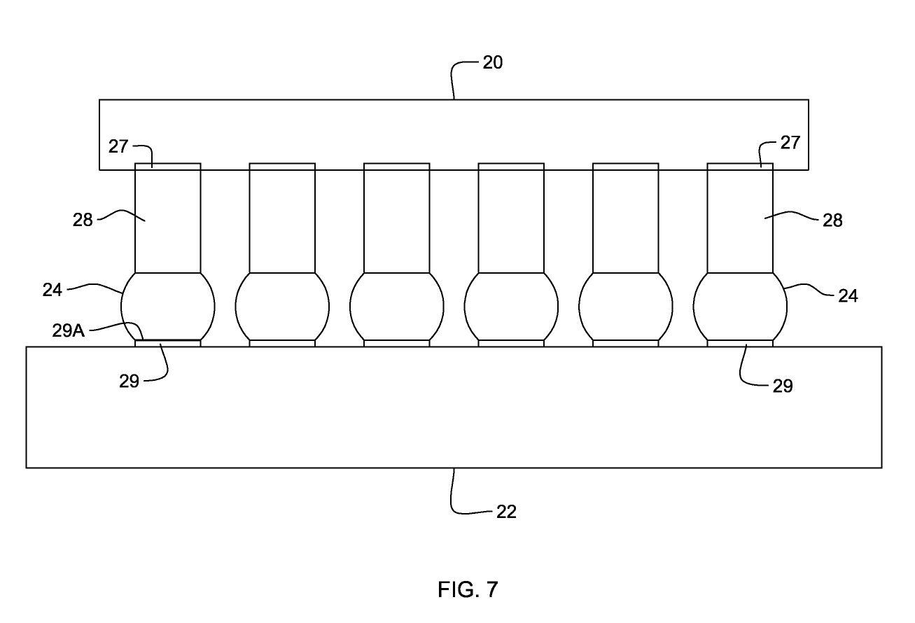

FIG. 7 is similar to FIG. 6, but uses a series of copper columns 28 (which may have a height of, for example, 10 to 50 microns) that may be formed on the UBM 27 of the chip 20. Solder 24 forms joints between copper column 28 and the pads 29 of the substrate 22. At the end of the columns 28, on the top of the pads 29, or either end, solders 24 in accordance with the invention may be used.

An important issue in the application of the present invention is how to include the proper amount of Zn, Bi, or Sb in the final solder joint. In accordance with the invention, the UBM may include layers of Cu or Ni, and Zn, Bi, or Sb. Alternatively, a layer of Zn may be sputtered onto the UBM containing for example, Cu or Ni. A laminate pad including CuZn plating, co-plating, or a zincate process may be used. In a zincate process a sample is put into zincate solutions contain zinc compounds and alkali hydroxides for generally less than 3 minutes and a zinc layer is formed on the UBM).

In the case of the substrate 22 in FIG. 6 or 7, (which may be, for example, Cu or a Cu OSP pad typical on organic laminate structures) layers of Cu or Ni may be deposited by coplating or sputtering. For example, a pad 29 of Ni in FIG. 6 or 7 may be sputtered with Cu 29A to control concentration of Cu in the solder joint. The concentration of the Cu in the solder may also be varied to control concentration of Cu in the solder joint.

In any case, a solder having less than the amount of Zn required, or none at all, may serve as the initial solder. However, with sufficient Zn associated with the UBM, upon reflow, the proper amount of Zn will be diffused into the final composition to form a solder in accordance with the present invention. In such cases, the interfacial intermetallic compounds which are produced will be favorably modified with respect to their usual compositions without the presence of Zn, so as to produce the more favorable solder joint characteristics disclosed herein.

The solders of the present invention are also useful for second level electrical interconnection, such as for example, between a substrate to which semiconductor chips have been bonded, and a circuit board. The pads on the substrate used to make electrical connection to a circuit board may use conventional solder bumps containing the required amount of Zn, or these pads may be bumped with Zn containing paste. Both active and passive components may be attached to the circuit board in this manner, with, for example, a solder comprising approximately 0.6 percent by weight Zn and 1.0 percent by weight Ag.

In summary, some of the solders which fall within the scope of the invention include those with low Ag content (0.5-1.5 wt. % Ag), as well as Zn doped SnAg, SnAgCu and SnCu solders (including solders generally with high Sn content). Low Ag, Sb doped solders, as well as Low Ag, Bi doped solders are also possible. The addition of Zn to a Sn—Bi eutectic alloy may also result in the elimination of so called “Kirkendall voiding”. For example a Sn—Ag—Cu solder joined to Cu and annealed at 150° C. for 1000 hours may contain voids which form an almost continuous layer and seriously impact the reliability of BGA joints. However, when the solder is doped with a small amount of Zn, the voids are eliminated.

Zn doping of solders using Ni pad structures will reduce the consumption of Ni. In “Directional growth of Cu3Sn at the reactive interface between eutectic SnBi solder and (100) single crystal Cu”, P. J. Shang et al., Scripta Materialia 59 (2008) 317-320, it was shown that Bi did not segregate to the Ni-IMC interface during thermal aging. Voiding of the sort associated with Cu pad structures did not occur. However, it is noted that the reduction in the Ni consumption rate will reduce the rate of Ni₃Sn layer formation and the associated void formation in association with this layer, which is a benefit of Zn doping in addition to the reduced electromigration benefits.

Zn doping, to minimize interfacial voiding, may be applicable to all Sn based solders, especially those utilizing Cu pad structures. In particular, any solder producing Cu₃Sn or Cu₃Sn and Cu₆Sn₅, interfacial, IMC structures will respond to the Zn doping, if the doping levels are appropriate. This criteria encompasses virtually all Sn based solders.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. A solder joint, comprising:
a solder capture pad on a surface; and
a lead free solder, the lead free solder being selected from the group comprising Sn—Ag—Cu solder and Sn—Ag solder adhered to said solder capture pad;
said solder selected from said group comprising between 0.1 and 2.0 percent by weight Sb or between 0.1 and 2.0 percent by weight Bi, and between 0.5 to 3.0 percent Ag.

2. The solder joint of claim 1, wherein the solder comprises less than 0.5% by weight Bi.

3. The solder joint of claim 2, wherein the copper content is between 0.7 and 2.0% by weight Cu.

4. The solder joint of claim 1, wherein said selected solder is Sn—Ag solder.

5. The solder joint of claim 1, wherein said solder capture pad is comprised of copper.

6. The solder joint of claim 1, comprising in the range of 1.0 to 2.0 percent Ag.

7. The solder joint of claim 1, comprising 1.3 percent Ag.

8. The solder joint of claim 1, further comprising a Cu pillar adhered to said solder, so that said solder forms an electrical connection between said pad and said pillar.

9. The solder joint of claim 1, wherein said solder is in the form of a solder bump, said solder bump being formed by one of solder bumping processes, including injection molding, paste screening, ball mount process, and a C4NP process.

10. A method for forming a solder joint on a solder capture pad on a surface, comprising:
applying to said capture pad a lead free solder, the lead free solder being selected from the group comprising Sn—Ag—Cu solder and Sn—Ag solder; and
adhering said solder to said solder capture pad by melting and cooling said solder;
said solder being selected from said group comprising between 0.1 and 2.0 percent by weight Sb or between 0.1 and 2.0 percent by weight Bi, and between 0.5 to 3.0 percent Ag.

11. The method of claim 10, wherein said selected solder comprises in the range of 1.0 to 2.0 percent Ag.

12. The method of claim 10, wherein the solder comprises 0.5% by weight Bi.

13. The method of claim 10, wherein the solder is a Sn—Ag—Cu solder and copper content is between 0.7 and 2.0% by weight Cu.

14. The method of claim 10, wherein said solder is heated to a temperature of less than 280° C. to melt said solder.

15. The method of claim 10, wherein said solder is heated to a temperature of between 217 and 280 degrees C. to melt said solder.

16. The method of claim 10, wherein said selected solder is Sn—Ag solder.

17. The method of claim 10, wherein said solder capture pad is comprised of copper or nickel.

18. The method of claim 10, further comprising placing an organic solderability preservative on said solder capture pad prior to applying said solder to said pad.

19. The method of claim 10, further comprising attaching a Cu pillar to said solder, so that said solder forms an electrical connection between said pad and said pillar.

20. The method of claim 10, wherein the solder is in the form of a solder bump, said solder bump being formed by one of solder bumping processes, including injection molding, paste screening, ball mount process, and a C4NP process.

21. The method of claim 10, wherein said solder is used to form a connection between a substrate to which semiconductor chips have been attached, and a circuit board.

22. The method of claim 10, used to form connections with a pitch of substantially 50 microns between adjacent connections.
